(19) United States
(12) Patent Application Publication
(10) Pub. No.: US 2014/0076801 A1
(43) Pub. Date: Mar. 20, 2014

(54) METHOD FOR THE SEPARATION OF LITTER FROM LIQUID MANURE

(71) Applicant: Roehren-und Pumpenwerk Bauer Ges.m.b.H., Voitsberg (AT)

(72) Inventor: Otto Roiss, Graz (AT)

(21) Appl. No.: 14/028,121

(22) Filed: Sep. 16, 2013

(30) Foreign Application Priority Data
Sep. 20, 2012 (DE) 10 2012 018 650.9

(51) Int. Cl. C02F 11/12; C02F 3/00

(52) U.S. Cl. CPC C02F 11/121; C02F 3/006
USPC 210/612; 210/742

(57) ABSTRACT

A method of separating litter from liquid manure includes feeding liquid manure to a separator and squeezing particulate material from the liquid manure with the separator at a separating rate. The method also includes feeding the material to a litter reclamation plant, heating the particulate material within the litter reclamation plant from an entry temperature to a target temperature, and maintaining the particulate material above the target temperature for a duration of time. The method further includes measuring the entry temperature for a predetermined measuring interval and adjusting the separating rate if the entry temperature increases or decreases within the measuring interval.

### FIELD OF THE INVENTION

The present invention relates to a method for extracting particulate material from liquid manure, and more particularly to a method for extracting litter from liquid manure.

### BACKGROUND OF THE INVENTION

Litter is used to cover the floor in stables, such as stables commonly found at dairy cattle farms, and is a requirement for keeping animals in hygienic conditions. From the prior art, various methods are known in which the particulate material in liquid manure is squeezed from the liquid manure to enable said particulate material in liquid manure to be subsequently used as litter. However, when using particulate materials in liquid manure as litter it is necessary to observe the EC regulation 1774/2002, “Health rules concerning animal by-products not intended for human consumption.” This prescribes inter alia that such products must undergo a heat treatment for at least one hour at more than 70 degrees Celsius. On account of this, said requirement lays down new conditions for the method for the separation of litter from liquid manure, the known methods not being able to fulfill said conditions. As a result, the prior art cannot reliably ensure the required heat treatment.

### SUMMARY OF THE INVENTION

The invention provides, in one aspect, a method which enables simple and cost-effective separation of litter from liquid manure, including a temporally defined heat treatment of the litter material in compliance with regulations.

The invention provides, in another aspect, a method for the separation of litter from liquid manure, wherein the following steps are undergone. Initially, the liquid manure to be used is fed to a separator which separates solid components and liquid components of the liquid manure. In the separator, a first quantity of a particulate material per unit of time is squeezed from the liquid manure. Likewise, a second quantity of the particulate material per unit of time is squeezed from the liquid manure by the separator. It is provided here that initially the first quantity per unit of time is squeezed from the liquid manure and subsequently the second quantity per unit of time. According to the invention, the first quantity per unit of time is squeezed within the duration of a predefined measuring interval. It is subsequently determined how large the second quantity per unit of time has to be. The determination of the second quantity per unit of time here follows a control process which is dependent on the further method steps. The particulate matter thus squeezed has a first content of dry matter, irrespective of whether the separator squeezes the first quantity per unit of time or the second quantity per unit of time.

Finally, the extracted particulate material is fed to a litter reclamation plant, in which the particulate material, proceeding from an entry temperature, is heated to a target temperature, while the particulate material is conveyed from an entry of the litter reclamation plant to an exit of the litter reclamation plant. The target temperature is typically reached prior to the exit of the litter reclamation plant, such that the particulate material in the course of the path yet to be covered up to the exit of the litter reclamation plant follows a temperature profile (is kept at a temperature) which is above the target temperature. It is thus possible to determine a first duration of time in which the particulate material is exposed to a temperature which lies above the target temperature. In order to keep the first duration of time above a preset value, according to the invention the quantity of the particulate material which is squeezed by the separator per unit of time, and which is thus fed to the litter reclamation plant per unit of time, is controlled depending on the entry temperature of the particulate material when entering into the litter reclamation plant. Thus the previously described determination of the second quantity per unit of time depends on the entry temperature of the particulate material. Should the entry temperature rise within the measuring interval, the first quantity is smaller than the second quantity. However, should the entry temperature drop within the measuring interval, then the first quantity is larger than the second quantity. On account of this feedback, the entry temperature which the particulate material has when filled into the litter reclamation plant can thus be held constant or at least within set limits.

The method according to the invention is carried out in that the separator squeezes the particulate material by means of a screw drive. To this end, for a screw diameter of about 260 millimeters (mm), a screw core of about 180 mm is used. The use of the screw drive permits, according to the invention, controlling of the torque, such that the content of dry matter of the squeezed particulate material can be adjusted via the torque of the screw drive. It is thus advantageously possible with the screw drive to always squeeze particulate matter with the first content of dry matter.

It is also provided that the first quantity per unit of time and the second quantity per unit of time are adjustable via the revolution speed of the screw drive. The output of the separator can thus be very easily adjusted. In conjunction with controlling of the torque, a decoupled system is thus available, since the content of dry matter is controlled by controlling of the torque, while the output quantity per unit of time is controlled via the revolution speed.

In an advantageous embodiment, the litter reclamation plant has a drum, wherein the drum rotates at a first rotational speed and the particulate material is transported parallel to the rotation axis. The rotation has the advantage that the particulate material which has been filled is mixed in the litter reclamation plant, such that a homogenous mixture occurs. It is likewise advantageous if the drum has insulation and/or is located in an insulated space. In this manner, heat losses can be decreased.

The rotational speed of the drum may be between about 0.5 revolutions per minute and about 1.5 revolutions per minute. Such a rotational speed enables a good mixing of the particulate material in the drum.

It is likewise provided that the filling level of the drum may be adjustable between about 45% and about 70% of a total capacity of the drum. In particular, the filling level of the drum may be about 65% of the total capacity of the drum. At such a filling level, the relative heat losses of the particulate material in the drum are particularly low.

It is further advantageous if the litter reclamation plant is ventilated via a ventilation plant. The air fed in this manner can be heated in order to heat the particulate material within the litter reclamation plant. The air here may be fed according to a counterflow method, such that the air is fed to the litter reclamation plant at the point at which the particulate material leaves the litter reclamation plant, while the air is evacuated at that point at which the particulate material is filled into the litter reclamation plant. Alternatively or additionally, it is advantageous to adjustably heat the particulate material prior to being fed to the litter reclamation plant. By way of example, the particulate material after squeezing by the separator can be conveyed through a further element which heats the particulate material before the particulate material is filled into the litter reclamation plant.

The method according to the invention is advantageously carried out in such a manner that the first duration of time is at least one hour and/or the measuring interval is a half hour. By selecting the first duration of time to be at least one hour, the requirement of the aforementioned EC regulation 1774/2002 is fulfilled. The selection of the measuring interval of a half hour is advantageous with respect to the stability of the control loop consisting of litter reclamation plant and separator. The selected durations of time thus enable the method according to the invention to be carried out safely and reliably.

The method according to the invention is likewise carried out in that the first content of dry matter may lie between about 35% and about 42%, particularly between about 37% and about 38%. These values, on the one hand, are readily achievable by the separator, and on the other hand it has been demonstrated that the litter should have a content of dry matter of approximately 40%. Since further drying takes place in the course of the particulate material passing though the litter reclamation plant, it is advantageous to select the first content of dry matter with which the separator squeezes the particulate material from the liquid manure to be between about 37% and 38%.

An entry temperature between about 50 degrees Celsius and about 60 degrees Celsius may be selected, wherein an entry temperature of about 55 degrees Celsius should particularly prevail. These values enable an optimal temperature profile of the particulate material over the length of the litter reclamation plant. It is further provided that the target temperature lies above about 70 degrees Celsius. It is ensured in this manner that the method according to the invention in this advantageous embodiment corresponds to the requirements of the mentioned EC regulation 1774/2002.

Since undershooting a predefined entry temperature even for a short term can no longer reliably ensure that the particulate material is being kept at above 70 degrees Celsius for at least one hour, as is prescribed by the EC regulation 1774/2002, it is advantageously provided that an alarm is emitted when a warning temperature is undershot. In this event, an operator can understand the situation and, if appropriate, manually introduce further countermeasures.

It is finally provided that a biocenosis is created in the litter reclamation plant, said biocenosis containing thermophilic bacteria. The biocenosis here may be influenced by the monitoring of the temperature profile of the entry temperature and controlling of the feed of the particulate material.

In one advantageous embodiment, the feeding of the liquid manure to the separator occurs from a central storage, wherein the liquid manure in the central storage can be advantageously homogenized by an agitator.

Besides, it is provided that the rise in temperature of the particulate material within the litter reclamation plant over the length of the litter reclamation plant is constant, such that the particulate material is conveyed from the entry of the litter reclamation plant to the exit of the litter reclamation plant and in the course of same is heated with a linear temperature profile.

Furthermore, the method according to the invention is applied continuously. This means that initially throughout the duration of the measuring interval, the first quantity of the particulate material per unit of time is squeezed, the second quantity per unit of time is subsequently determined, such that the second quantity of particulate material per unit of time is squeezed throughout the duration of the measuring interval, and subsequently the method according to the invention starts afresh. Thus the now squeezed second quantity of the particulate material per unit of time is again considered to be a first quantity of the particulate material per unit of time, and after expiry of the measuring interval again a second quantity per unit of time is determined. In this manner, the entry temperature can be advantageously continuously controlled within predefined limits.

Other features and aspects of the invention will become apparent by consideration of the following detailed description and accompanying drawings.

### BRIEF DESCRIPTION OF THE DRAWINGS

FIG. 1 is a schematic overview of a plant with which the method according to an embodiment of the invention can be carried out.

FIG. 2 is a schematic configuration of a separator of the plant of FIG. 1.

FIG. 3 is a schematic overview over a logical configuration of the plant of FIG. 1.

FIG. 4 is a schematic overview over the litter reclamation plant and the temperature profile of a particulate material therein, in the event that the method according to the invention is applied according to the exemplary embodiment.

FIG. 5 is an exemplary profile of the entry temperature in the application of the method according to the invention according to the exemplary embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

FIG. 1 shows a plant with which the method according to the invention can be carried out. Here, liquid manure 1 is collected in a collection container 100 and advantageously homogenized by an agitator 102. The liquid manure 1 is finally fed to the separator 2 via a pump 101, said separator 2 being configured to separate solid components 11 from liquid components 12 of the liquid manure 1. The liquid components 12 of the manure are not required further here and thus removed. The solid components comprise, for example, the particulate material 6 which is fed by a screw conveyor 9 to the litter reclamation plant 3.

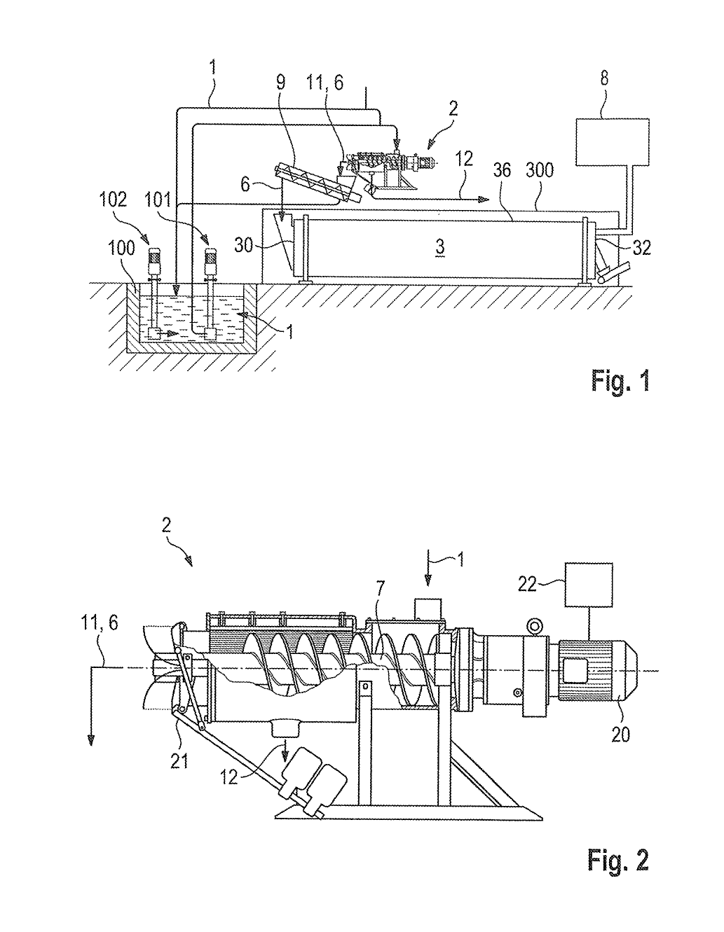

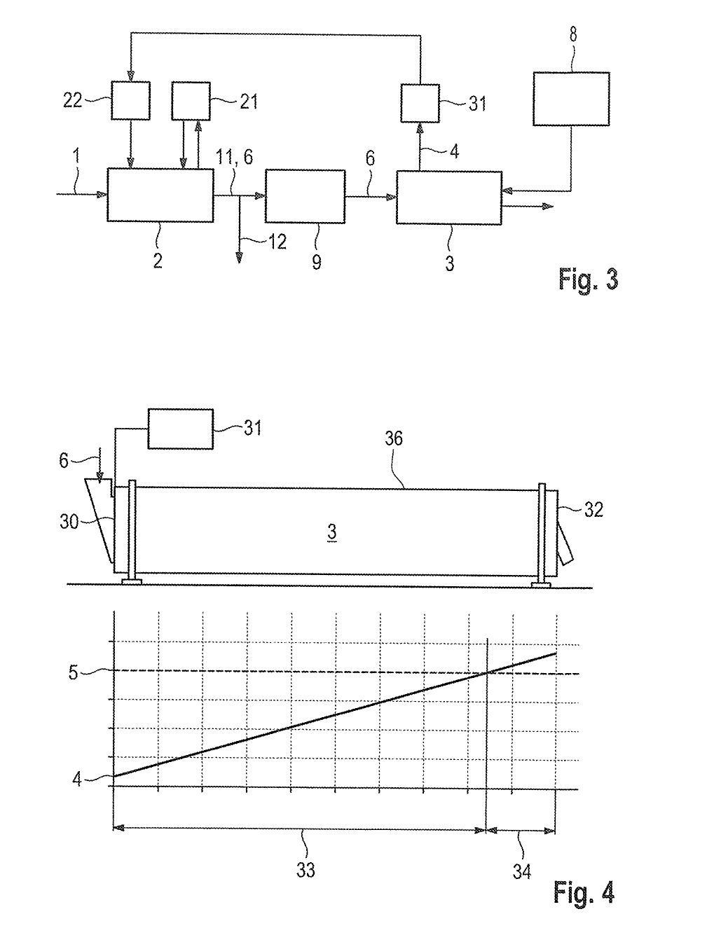

The separator 2 is illustrated in detail in FIG. 2. Thus the liquid manure 1 is filled into the separator 2 and compressed via a screw drive 7, such that solid components 11 and liquid components 12 are discharged from the separator 2. The screw drive 7 is driven by a motor 20, wherein torque and revolution speed of the motor 20 are separately controlled. On the one hand, the revolution speed of the motor 20 is controlled by a revolution speed controller 22. The revolution speed controller 22 thus obtains a signal feedback which shall be considered in more detail in FIG. 3. Furthermore, the separator 2 has a torque controller 21 which exerts a counterpressure on the particulate material 6 exiting from the separator 2. The motor 20 thus has to generate a corresponding torque in order to overcome the counterpressure of the torque controller 21. By selecting the counterpressure, the torque controller 21 can thus control the torque of the motor 20. By way of interaction, revolution speed controller 22 and torque controller 21 can thus precisely determine the content of dry matter of the exiting particulate material 6. On the other hand, the separator 2, by a modification of the revolution speed of the motor 20, can increase or decrease the output rate of the particulate material 6. The separator 2 can thus both react to the requirements placed by the litter reclamation plant 3 on the quantity of the discharged particulate material 6, and also the separator 2 can ensure that the discharged particulate material 6 always has a first content of dry matter. This is advantageous in as far as the liquid manure 1 mostly varies very much in its composition on account of different external influences, such as varying fodder compositions in different seasons; cleaning methods using more or less water depending on varying requirements; wet, cold, warm or dry periods of weather; or decomposition processes as a result of different storage periods. It can thus be achieved by means of the separator 2 that the particulate material 6, which is fed to the litter reclamation plant, always has a consistent content of dry matter.

In FIG. 1, the litter reclamation plant 3 is furthermore illustrated. In the illustrated embodiment, the litter reclamation plant 3 includes a drum 36 having an overall length of about 10 m. Moreover, the drum 36 is rotated at a speed of 0.5 to 1.5 revolutions per minute, the drum 36 being rotated, for example, at a speed of 1 revolution per minute. At a first end side 30 of the litter reclamation plant 3, the particulate material 6 is fed. The particulate material 6 subsequently passes through the litter reclamation plant 3 in order to be finally discharged again at the second end side 32. Furthermore, a ventilation device 8 is provided which introduces air at the second end side 32 of the litter reclamation plant 3 and evacuates air at the first end side 30. The air fed through the ventilation unit 8 here can be heated, such that the temperature within the litter reclamation plant 3 can be influenced. It is likewise possible to heat the particulate material 6 via the screw conveyor 9 in order to adjust the entry temperature of the particulate material 6 at the first end side 30 of the litter reclamation plant. Finally, the litter reclamation plant 3 has insulation and is located within an insulated container 300.

FIG. 3 shows the logical configuration of the plant described earlier, as it is schematically illustrated in FIGS. 1 and 2. In the schematic of FIG. 3, arrows which vertically meet a component indicate flows of information, while arrows which horizontally meet a component indicate flows of mass.

Liquid manure 1 is initially fed to a separator 2. The separator 2 is equipped to separate the liquid manure 1 into solid components 11 and liquid components 12. In the separator 2, a particulate material 6 is thus squeezed. A separating rate (i.e., the quantity of particulate material discharged by the separator 2 per unit of time) and the dry matter content of the particulate material are controllable via the revolution speed controller 22 and via the torque controller 21. Initially, a first quantity of the particulate material 6 per unit of time is discharged to the screw conveyor 9. The screw conveyor 9 conveys the first quantity of the particulate material 6 per unit of time to the litter reclamation plant which is in this manner filled by the screw conveyor 9 with the particulate material 6. A temperature sensor 31 is located on the litter reclamation plant 3 and determines an entry temperature 4 of the fed particulate material 6. As soon as a measuring interval, for example 30 minutes, has expired, the temperature sensor 31 detects the entry temperature 4 and feeds said entry temperature 4 back to the revolution speed controller 22. By means of this signal feedback a control loop is created, since the revolution speed controller 22 controls the revolution speed of the motor 20 of the separator 2 based on the entry temperature 4. Should the entry temperature 4 have risen within the measuring interval, the separator 2 is activated by the revolution speed controller 22 such that from this point onward a second quantity of the particulate material 6 per unit of time is squeezed, wherein the second quantity is larger than the first quantity. In other words, the separating rate is increased. On the other hand, should the entry temperature 4 have dropped within the measuring interval, then the second quantity is smaller than the first quantity (i.e., the separating rate is decreased). In this manner, the entry temperature 4 of the particulate material 6 at the litter reclamation plant 3 can either be lowered by increasing the separating rate, or increased by decreasing the separating rate. Thus a continuous process is created in which the entry temperature 4 serves as control variable and the revolution speed of the motor 20 as manipulated variable.

Additionally to the abovementioned control arrangement it is furthermore possible to feed heated air via the ventilation plant 8 to the litter reclamation plant 3 in order to further increase the temperature of the particulate material 6 within the litter reclamation plant. Alternatively or additionally, the screw conveyor 9 can also heat the particulate material 6 prior to being fed to the litter reclamation plant 3.

FIG. 4 schematically shows the configuration of the litter reclamation plant 3. Here, the particulate material 6 is fed at a first end side 30, wherein the temperature sensor 31 determines the entry temperature 4 of the particulate material 6 likewise at the first end side 30. Also in FIG. 4, a diagram is illustrated which in the vertical axis illustrates the temperature profile over the length of the litter reclamation plant (longitudinal axis). It is evident that the temperature profile is linear. Proceeding from an entry temperature 4, the temperature of the particulate material 6 rises, wherein the temperature within a first region 33 of the litter reclamation plant lies below a target temperature 5. In a second region 34 of the litter reclamation plant, however, the temperature of the particulate material 6 lies above the target temperature 5.

The particulate material 6 is, for example, conveyed through the litter reclamation plant 3 at a speed of about 1 meter per hour. It thus arises that the first region 33 can be of a maximum length of 9 meters so that the second region 34 can have a length of at least 1 meter. It is ensured in this case that the particulate material 6 is kept for at least 1 hour within the second region 34 in order to be subjected to a heat treatment of at least 1 hour above the target temperature 5. The target temperature here is, for example, 70 degrees Celsius. The entry temperature 4 here according to the invention is about 50 degrees Celsius. Thus a favorable temperature profile over the length of the litter reclamation plant 3 arises.

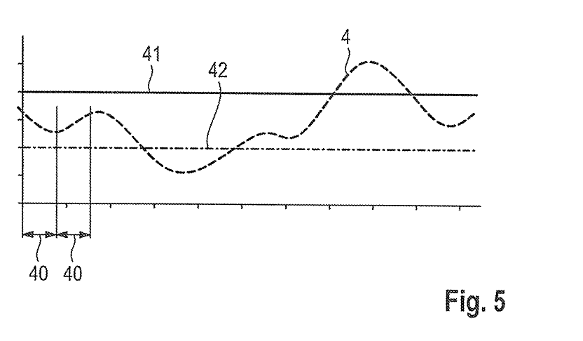

FIG. 5 schematically shows a temperature profile of the entry temperature 4. Here, the vertical axis illustrates the value for the temperature 4, while the horizontal axis represents the time axis. An upper limit temperature 41 and a lower limit temperature 42 indicate a working region in which the entry temperature 4 must be kept in order to enable the required heat treatment of the particulate material 6 to be safely and reliably carried out. According to the invention it is, therefore, determined after a first measuring interval 40, for example after a half hour, that the entry temperature 4 has dropped. Therefore, this temperature information is used to slow by an adjustable value the revolution speed of the motor 20 of the screw drive 7 by means of the revolution speed controller 22, which is, for example, configured as a frequency converter. Therefore, however, the particulate material 6 now remains longer in the screw drive 7 of the separator 2, which would lead to an increase in the content of dry matter of the particulate material 6. The increase in the content of dry matter of the particulate material 6 means, however, also an increase in the torque which acts on the screw drive 7. Thus the torque controller 21 can counteract said increase in torque and lower the torque which acts on the screw drive 7. In this manner, the content of dry matter of the particulate material 6 is kept constant. Overall, less particulate material is discharged to the litter reclamation plant 3, as a result of which the entry temperature 4 increases in a next measuring interval 40.

Should the entry temperature 4 drop below the lower limit 42 or exceed the upper limit 41, the optimal working region is thus exited and the risk exists that the required heat treatment of the particulate material 40 no longer occurs as required. In this case, for example an alarm can be triggered in order to alert a plant operator to this situation.

In particular during winter months the method according to the invention is particularly advantageous, because sudden cold spells can lead to malfunctions in the operating procedure of a conventional plant for the extraction of litter from liquid manure. In order to counter such situations, the heated air can be fed via the ventilation device 8 to the litter reclamation plant 3, or the particulate material 6 can be heated by the screw conveyor 9 prior to being fed to the litter reclamation plant 3. Overall it is thus ensured that a biocenosis is created in the litter reclamation plant 3 by the method according to the invention, at the end of which biocenosis there is a heat treatment of the fed particulate material 6 in which the particulate material 6 is kept above a temperature of 70 degrees Celsius, the heat treatment lasting at least 1 hour.

Various features of the invention are set forth in the following claims.

What is claimed is:

1. A method of separating litter from liquid manure, the method comprising:
feeding liquid manure to a separator;
squeezing particulate material from the liquid manure with the separator at a separating rate;
feeding the particulate material to a litter reclamation plant;
heating the particulate material within the litter reclamation plant from an entry temperature to a target temperature;
maintaining the particulate material above the target temperature for a duration of time;
measuring the entry temperature for a predetermined measuring interval; and
adjusting the separating rate if the entry temperature increases or decreases within the measuring interval.

2. The method of claim 1, wherein adjusting the separating rate includes increasing the separating rate if the entry temperature increases within the measuring interval and decreasing the separating rate if the entry temperature decreases within the measuring internal.

3. The method of claim 1, wherein the duration of time is at least one hour.

4. The method of claim 1, wherein the separator squeezes the particulate material by means of a screw drive.

5. The method of claim 4, further comprising controlling a torque of the screw drive to adjust a dry matter content of the particulate material.

6. The method of claim 4, wherein adjusting the separating rate includes adjusting a revolution speed of the screw drive.

7. The method of claim 1, wherein the litter reclamation plant includes a drum that is rotated at a rotational speed.

8. The method of claim 7, wherein the rotational speed is between about 0.5 revolutions per minute and about 1.5 revolutions per minute.

9. The method of claim 7, wherein a filling level of the drum is adjustable between about 45% and about 70% of a total capacity of the drum.

10. The method of claim 9, wherein the filling level is about 65% of the total capacity of the drum.

11. The method of claim 1, wherein heating the particulate material includes feeding heated air to the litter reclamation plant via a ventilation plant, and wherein the method further comprises adjusting the quantity of heated air fed to the litter reclamation plant.

12. The method of claim 1, further comprising adjustably heating the particulate material prior to feeding the particulate material to the litter reclamation plant.

13. The method of claim 1, wherein the measuring interval is about one half hour.

14. The method of claim 1, wherein the particulate material has a dry matter content between about 35% and about 42%.

15. The method of claim 14, wherein the particulate material has a dry matter content between about 37% and about 38%.

16. The method of claim 1, wherein the entry temperature is between about 50 degrees Celsius and about 60 degrees Celsius, and the target temperature is greater than about 70 degrees Celsius.

17. The method of claim 16, wherein the entry temperature is about 55 degrees Celsius.

18. The method of claim 1, further comprising triggering an alarm signal if the entry temperature exceeds a predetermined upper limit or if the entry temperature falls below a predetermined lower limit.

19. The method of claim 1, further comprising creating a biocenosis in the litter reclamation plant.

20. The method of claim 19, wherein the biocenosis contains thermophilic bacteria.
